(19) United States
(12) Patent Application Publication
(10) Pub. No.: US 2026/0067232 A1
(43) Pub. Date: Mar. 5, 2026

(54) PROACTIVE NETWORK BANDWIDTH MANAGEMENT

(71) Applicant: CAST AI Group, Inc., Miami, FL (US)

(72) Inventor: Augustinas Stirbis, Vilnius (LT)

(21) Appl. No.: 19/050,024

(22) Filed: Feb. 10, 2025

Related U.S. Application Data
(60) Provisional application No. 63/688,979, filed on Aug. 30, 2024.

(51) Int. Cl. H04L 47/80; H04L 43/0882; H04L 47/12

(52) U.S. Cl. CPC H04L 47/801; H04L 43/0882; H04L 47/12

(57) ABSTRACT

A system for managing network bandwidth as a resource in cloud computing environments. The system obtains the network bandwidth capacity of each node within a cloud environment based on metadata provided by a cloud service provider. The system assigns a network bandwidth requirement to each workload scheduled on the nodes. The system tracks the available network bandwidth of each node dynamically by deducting the bandwidth requirements of scheduled workloads from the node's total bandwidth capacity. Dynamically tracking the available network bandwidth of each node includes in responds to scheduling a first workload on a node based on the node's bandwidth capacity and the workload's bandwidth requirement, updating the node's available bandwidth, and a second workload is scheduled based on the updated availability.

### CROSS REFERENCE TO RELATED APPLICATION

This application claims priority to U.S. Provisional Patent Application Ser. No. 63/688,979, filed Aug. 30, 2024, which is incorporated herein by reference in its entirety.

### TECHNICAL FIELD

This disclosure relates generally to cloud computing, and more specifically proactive network bandwidth management.

### BACKGROUND

In cloud computing environments, such as Kubernetes-managed infrastructures, resources generally refer to compute (e.g., CPUs), memory (e.g., RAM), storage (e.g., disks). A cloud system (e.g., Kubernetes) allocates these resources to ensure applications perform efficiently, reliably, and with scalability. For example, the cloud system may schedule CPU for a container based on the container's request. If the container requests 0.5 CPU, the cloud system schedules it on a node with at least 0.5 CPU available. The cloud system may also set a maximum amount of CPU that the container can use, such as 1 CPU. As such, the container may be able to use CPU beyond its request (e.g., 0.5 CPU), up to the maximum amount (e.g., 1 CPU) if spare capacity is available.

Similarly, the cloud system may also schedule memory for a container based on the container's request. The cloud system may also set a maximum amount of memory the container is allowed to use. The maximum amount may be greater than the requested amount. If the container exceeds the maximum limit, the container will be terminated with an out of memory killed error. The cloud system checks whether a node has sufficient free memory to satisfy the container's request. A node with less than the requested amount of memory will not be considered for scheduling.

However, existing cloud systems generally do not consider network as a resource like compute, memory, or storage. Unlike CPU, memory, and disk, a cloud system does not explicitly allocate or reserve network bandwidth for a container or pod, and there are no built-in mechanisms in cloud computing environment for specifying or enforcing network bandwidth requests or limits directly in a container's resource configuration, nor network bandwidth is used in scheduling decision making (allocating Pod with high network needs on a node that has already saturated network. Because the cloud system does not natively allocate, limit or schedule based on network bandwidth, a workload can consume excessive bandwidth, leaving others starved for network resources. Further, without explicit network resource allocation, workloads with high throughput or low-latency requirements can suffer in shared environments.

### SUMMARY

The embodiments described herein address the above-described problems by providing a mechanism for defining network bandwidth as a resource requests in a cloud computing environment, similar to CPU and memory. As such, workloads can be scheduled on a Node with enough network bandwidth (that was not already soft allocated to other workloads) and/or if that kind of node does not exist in Kubernetes cluster to create just in time new Node and schedule workload on newly created Node to satisfy workload's network bandwidth requirements.

In some embodiments, a system obtains the network bandwidth capacity of each of a plurality of nodes within a cloud computing environment based on metadata provided by a cloud service provider. Network bandwidth is treated as a resource, and a network bandwidth requirement is assigned to each of a plurality of workloads scheduled on the nodes. The system tracks the available network bandwidth of each node by accounting for the scheduled workloads and their respective network bandwidth requirements. Tracking the available network bandwidth of each node includes scheduling a first workload on a node based on the node's network bandwidth capacity and the workload's bandwidth requirement, updating the node's available bandwidth by deducting the bandwidth requirement of the first workload, scheduling a second workload on the node based on the updated available bandwidth, and further updating the available bandwidth by deducting the second workload's bandwidth requirement.

In some embodiments, the system further updates the network bandwidth requirement for the first workload or the second workload based on current network bandwidth metrics collected during the operation of the first workload or the second workload and updates the available network bandwidth for the node based on the updated network bandwidth requirement. For example, the network bandwidth metrics may include one or more of the following: packet loss, queue depth, TCP retransmissions, round-trip time, and latency jitter.

In some embodiments, the system determines whether a network bandwidth metric for any node has deteriorated to a predetermined threshold. In response to determining that the network bandwidth metric for at least one node has deteriorated to the predetermined threshold, the system may provision an additional node to redistribute workloads on the at least one node. Alternatively, the system may be killed or live migrated to another node.

In some embodiments, the system assigns a network bandwidth limit to a workload, such as an ingress bandwidth limit and an egress bandwidth limit. The system monitors the network bandwidth consumption of the workload to determine whether the network bandwidth consumption of the workload reaches the network bandwidth limit. In response to determining that the network bandwidth consumption of the workload reaches the network bandwidth limit, the system enforces the network bandwidth limit by throttling network traffic speed associated with the workload to cause the network bandwidth consumption of the workload to be within the network bandwidth limit.

These embodiments provide efficient allocation and management of network bandwidth resources, enabling optimized workload scheduling and preventing network congestion.

### BRIEF DESCRIPTION OF THE DRAWINGS

FIG. 1 is a block diagram of a system environment in which an automation system may be implemented, in accordance with one or more embodiments.

FIG. 2 illustrates an example architecture of a network resource allocation module in accordance with one or more embodiments.

FIG. 3A is a block diagram of a node in which a traffic collection agent is executed in a kernel to collect traffic flow data associated with the node in accordance with one or more embodiments.

FIG. 3B is a block diagram of a Kubernetes cluster including multiple nodes, in each of which a traffic collection agent is executed in a kernel to collect traffic flow data associated with a corresponding node, in accordance with one or more embodiments.

FIG. 4 illustrates an example graphical user interface (GUI) that provides insights into network costs, traffic, and resource usage across workloads in a Kubernetes-managed environment, in accordance with one or more embodiments.

FIG. 5 illustrates a data structure describing a compute instance's attributes, in accordance with one or more embodiments.

FIG. 6 illustrates an example code snippet that advertises that a node has a specific network bandwidth capacity, in accordance with one or more embodiments.

FIG. 7 illustrates an example configuration file describing a Kubernetes Pod with specific resource requests, including limits for network bandwidth using a custom resource field, in accordance with one or more embodiments.

FIG. 8 is a flowchart of a method for network-aware workload scheduling and bandwidth management in a cloud computing environment, in accordance with one or more embodiments.

FIG. 9 is a block diagram of an example computer suitable for use in a networked computing environment in accordance with one or more embodiments.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

In traditional cloud computing environments, resources such as CPU, memory, and storage are explicitly allocated and managed to ensure efficient, reliable, and scalable application performance. However, these systems typically overlook network bandwidth as a resource, leaving it unmanaged and unallocated. This omission creates challenges in shared environments where workloads can consume excessive bandwidth, resulting in resource starvation for other workloads. Additionally, workloads requiring high throughput or low latency often experience degraded performance due to the lack of guaranteed network bandwidth allocation.

An automated system described herein addresses these shortcomings by introducing network bandwidth as a managed resource in cloud computing environments, similar to CPU and memory. By treating network bandwidth as an allocatable resource, the system schedules workloads to enable guaranteed bandwidth allocation and imposes mechanisms to prevent overconsumption. The system tracks the network bandwidth capacity of each node and assigns specific bandwidth requirements to workloads. This resource-aware scheduling ensures that workloads are deployed only on nodes with sufficient available bandwidth. Furthermore, dynamic updates based on real-time metrics, such as packet loss and latency, allow for near real-time adjustments to maintain performance. This approach ensures fair bandwidth distribution, optimized workload scheduling, and improved performance for bandwidth-sensitive applications.

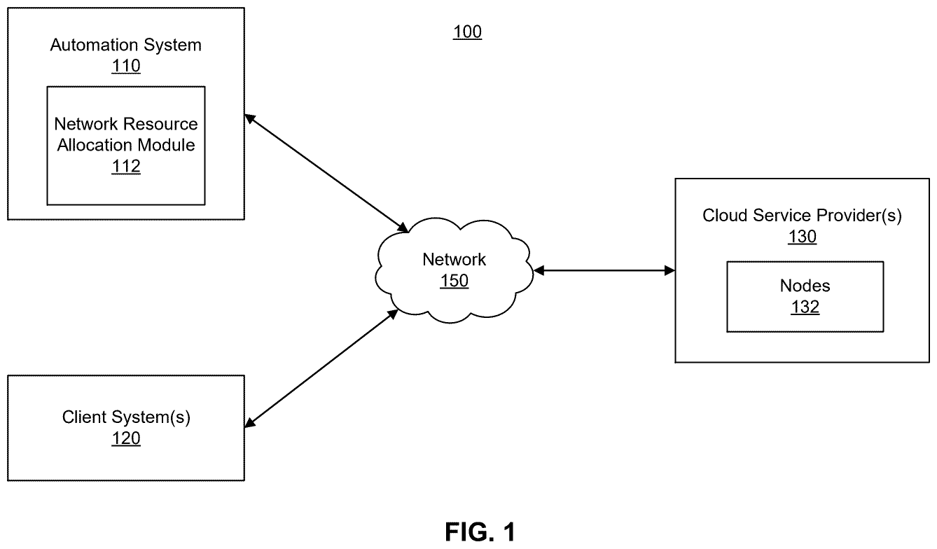

Additional details about the system are further described below with respect to FIGS. 1-9.

### System Architecture

FIG. 1 is a block diagram of a system environment 100 in which an automation system 110 (also referred to “the system”) may be implemented in accordance with one or more embodiments. The environment 100 includes the automation system 110, one or more client devices 120, and one or more cloud service provider(s) 130, all interconnected via a network 150. The cloud service provider(s) 130 host one or more nodes 132, which may be virtual machines (VMs). The cloud service provider(s) 130 may include (but are not limited to) Amazone Web Services (AWS)®, Google Cloud Platform (GCP)®, and/or Microsoft Azure®. The cloud service provider 130 provides computing resources, such as VMs, storage, and networking, over the network 150. VMs are scalable, software-based representations of physical machines that can run operating systems and applications. Networking includes virtualized network components, such as firewalls, and virtual private networks (VPNs). These resources may be made available to users on-demand, enabling flexibility and scalability. In some embodiments, the nodes 132 are part of a Kubernetes cluster, which is a distributed system for managing containerized applications across multiple VMs. Additional details about clusters and Kubernetes services are described in U.S. patent application Ser. No. 17/380,729, filed Jul. 20, 2021 (now issued as U.S. Pat. No. 11,595,306), which is incorporated herein in its entirety.

The network resource allocation module 112 is configured to obtain a network bandwidth capacity of each of a plurality of nodes 132 based on metadata of the plurality of nodes 132 provided by the cloud service provider 130. The network resource allocation module 112 assigns a network bandwidth requirement as a resource associated with each of a plurality of workloads scheduled on the plurality of nodes 132. The network resource allocation module 112 tracks an available network bandwidth of each of the plurality of nodes 132 based on the scheduled workloads and their corresponding network bandwidth requirements.

In some embodiments, the network bandwidth requirement for each workload is determined based on historical network usage metrics of the workload. In some embodiments, the network resource allocation module 112 collects current network bandwidth metrics of the first workload or the second workload from the node 132. The current network bandwidth metrics include one or more of packet loss, queue depth, TCP retransmissions, round trip time, and latency jitter. The network resource allocation module 112 then updates the network bandwidth requirement for the first workload or the second workload based on the current network bandwidth metrics, and updates the available network bandwidth for the node based on the updated network bandwidth requirement for the first workload or the second workload.

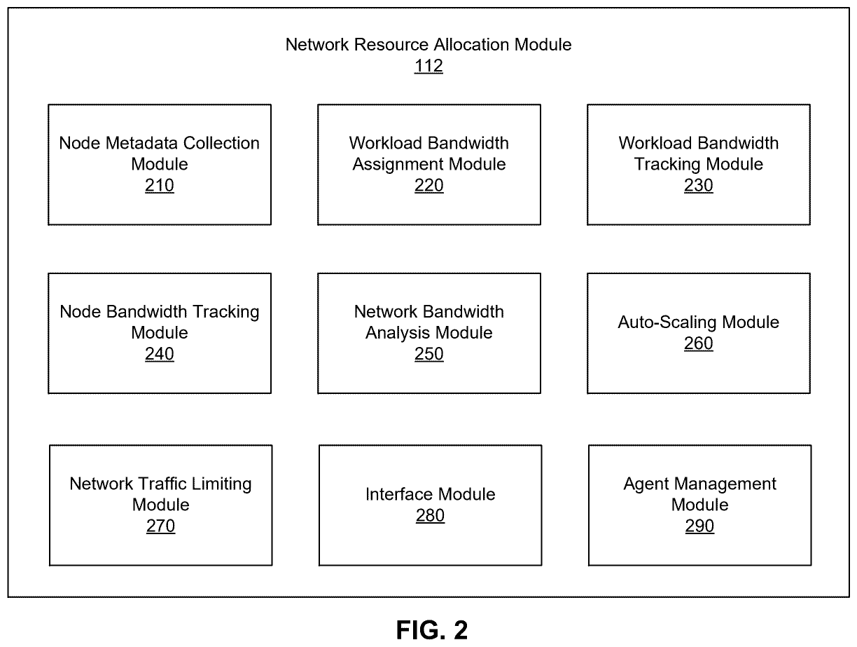

In some embodiments, the network bandwidth metrics are collected by an agent (DaemonSet) deployed onto each of the plurality of nodes 132. Each agent is attached to network-related system calls in a kernel of the node (eBPF). The agent is configured to monitor real time network traffic based on the network related system calls in the kernel and determine the current network bandwidth metrics of each workload. The network resource allocation module 112 can also trigger autoscale or migration of workload based on the updated available network bandwidth for each node 132 and network bandwidth metrics of each workload. Additional details about the network resource allocation module 112 and agents for determining network bandwidth metrics are further described below with respect to FIGS. 2-9.

The client device(s) 120 are computing systems associated with various entities. These entities include entities that can provision nodes 132 on the cloud service provider 130, as well as end-users who engage with applications deployed onto the nodes 132. The client devices 120 are also capable of receiving user input as well as transmitting and/or receiving data via the network 150. In one embodiment, a client device 120 is a computer system, such as a desktop or a laptop computer. Alternatively, a client device 120 may be a device having computer functionality, such as a personal digital assistant (PDA), a mobile telephone, a smartphone, or another suitable device. A client device 120 is configured to communicate via the network 150. In one embodiment, a client device 120 executes an application allowing a user of the client device 120 to interact with the automation system 110. For example, the client device 120 may execute a customer mobile application to enable interaction between the client device 120 and the automation system 110 or the cloud service providers 130. As another example, a client device 120 executes a browser application to enable interaction between the client device 120 and the system 110 via the network 150. In another embodiment, a client device 120 interacts with the system 110 through an application programming interface (API) running on a native operating system of the client device 120, such as IOS® or ANDROID™.

The network 150 is configured to facilitate communications among the automation system 110, client device 120, and cloud service provider 130. The network 150 may comprise any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

### Example Architecture of Automation System

FIG. 2 illustrates an example architecture of a network resource allocation module 112, in accordance with one or more embodiments. The network resource allocation module 112 includes a node metadata collection module 210, a workload bandwidth assignment module 220, a workload bandwidth tracking module 230, a node bandwidth tracking module 240, a network bandwidth analysis module 250, an auto-scaling module 260, a network traffic limiting module 270, an interface module 280, and an agent management module 290. In some embodiments, modules within the network resource allocation module 112 can be configured flexibly: multiple modules may be combined into one to perform a range of functions, or a single module might be split into several, with each handling a specific subset of tasks. Some functions of these modules are performed by a combination of the network resource allocation module 112, the client device 120, and the cloud service provider 130, and/or other devices.

The node metadata collection module 210 is configured to collect metadata about nodes 132 within the cloud computing environment, including network bandwidth capacity of each node 132. In some embodiments, the node metadata collection module 210 periodically queries the cloud service provider's APIs to retrieve a list of active nodes, along with their metadata, e.g., node names, regions, zones, and their network bandwidth capacity.

The workload bandwidth assignment module 220 is configured to assign a network bandwidth requirement to each workload. The network bandwidth requirement is the minimum bandwidth that the workload is guaranteed to be allocated. In some embodiments, the workload bandwidth assignment module 220 is also configured to assign a limit to each workload. The limit is the maximum bandwidth that the workload is allowed to use. The maximum bandwidth is no less than the bandwidth requirement. In some embodiments, the requirement and limit for bandwidth assignments are initially determined and entered by users. After the workload is deployed onto a node, the system 110 can track bandwidth consumption over a range of time and then update the assigned requirement and limit for bandwidth based on the tracked bandwidth consumption. For example, the bandwidth requirement may be set at the 50th percentile of the tracked bandwidth consumption, and the bandwidth limit may be set at the 95th percentile.

The workload bandwidth tracking module 230 is configured to track network bandwidth usage for workloads running on nodes. In some embodiments, the workload bandwidth tracking module 230 receives network bandwidth metrics from each nodes. The network bandwidth metrics may include (but are not limited to) packet loss, queue depth, TCP retransmissions, roundtrip time, and/or latency jitter. Packet loss occurs when one or more packets of data travelling across the network 150 fail to reach their destination. Packet loss is often caused by network congestion. Packet loss will trigger retransmissions, which will increase latency and further congest the network. Queue depth refers to a number of packets waiting in a node's buffer to be transmitted or processed. A high queue depth also indicates high traffic loads and network congestion. Roundtrip time (RTT) is the time it takes for a packet to travel from a sender node to a receiver node and back again, including the time for the receiver to send an acknowledgment. A higher RTT means slower communication between nodes, resulting in long latency. Latency jitter refers to a variation or inconsistency in packet arrival times. Even when packets arrive, if they arrive out of order or with unpredictable timing, it is considered jitter. Latency jitter is also caused by network congestion. These network metrics can be used to estimate bandwidth usage of each node.

In some embodiments, these metrics are collected by agents deployed on to each node 132. The agent management module 290 is configured to deploy and manage agents on nodes 132 in the cloud computing environment. In some embodiments, the agent management module 290 is configured to identify nodes in the cloud computing environment where agents need to be deployed. In some embodiments, the agent management module 290 is configured to query a Kubernetes API or a cloud service provider API to retrieve node metadata, such as node name, IP addresses, and zones. In some embodiments, agent management module 290 may also manage agent configuration and updates. The agent management module 290 may configure each agent with proper parameters for deployment of the agent. Such parameters may include (but are not limited to) access credentials for secure communication with the automation system 110, and filters or rules for collecting specific types of network traffic. In some embodiments, the agent management module 290 is configured to generate configuration files to tailor the agent's behavior based on node-specific or workload-specific attributes.

After the agents are deployed, the agent management module 290 may continuously monitor the status of each agent to ensure they are running and functioning as expected. For example, the agent management module 290 may be configure to receive heartbeat signals from each agent to verify their availability, and collects logs from agents to detect issues like crashes or resource exhaustion. In response to detecting agent failures or errors, the agent management module 290 may initiates recovery processes, such as restarting the agent, re-deploying the agent, or alerting an administrator. The agent management module 290 may also be configured to update agents with new configurations or software versions without disrupting the node's workload, and/or apply patches to address bugs or enhance functionality. Additional details about the agent management module 290 are further described below with respect to fogs 3A-3B.

The node bandwidth tracking module 240 is configured to track available network bandwidth of each node. As described above with respect to node metadata collection module 210, each node has a network bandwidth capacity that can be obtained from metadata of each node. However, after a workload is scheduled onto a node, the available network bandwidth of that node is reduced. The node bandwidth tracking module 240 is configured to track the workloads deployed onto each node, and determine the available network bandwidth of each node based on the deployed workloads.

For example, initially, before any workload is scheduled onto a node, the node's available network bandwidth is same as its network bandwidth capacity obtained from the metadata, e.g., 12.5 Gbi. After a first workload (assigned a first network bandwidth requirement, e.g., 5 Gbi) is scheduled onto the node, the node bandwidth tracking module 240 determines an updated available network bandwidth of the node by deducting the first network bandwidth requirement from the network bandwidth capacity of the node, e.g., 7.5 Gbi=12.5 Gbi−5 Gbi. After a second workload (assigned a second network bandwidth requirement, e.g., 4 Gbi) is scheduled onto the node, the node bandwidth tracking module 240 determines another updated available network bandwidth of the node by deducting the second network bandwidth requirement from the current available network bandwidth capacity of the node, e.g., 3.5 Gbi=7.5 Gbi−4 Gbi. As such, the node bandwidth tracking module 240 tracks available network bandwidth of each node in the cloud computing system.

The network bandwidth analysis module 250 is configured to analyze the network bandwidth of each node and workload to determine whether a workload should be migrated to another node, or whether a new node should be provisioned. In some embodiments, the network bandwidth analysis module 250 determines whether an available network bandwidth of any node is below a predetermined threshold. In response to determining that an available network bandwidth of a node is below a predetermined threshold, the network bandwidth analysis module 250 selects a workload from the node and migrates the workload to another node, which may be an existing running node, or a new node that is to be provisioned, depending on the available network bandwidth of the remaining nodes in the cloud computing environment. For example, in response to determining that all other nodes' available network bandwidth is less than the network bandwidth requirement of the workload, the network bandwidth analysis module 250 determines that a new node should be provisioned, and the workload is to be migrated to the new node. Otherwise, the network bandwidth analysis module 250 identifies a currently running node that has an available network bandwidth greater than the network bandwidth requirement of the workload, and migrate the workload to the identified node.

In some embodiments, the network bandwidth analysis module 250 determines whether a workload should be migrated from one node to another based on the presence and volume of cross-zone traffic between the two nodes. In response to determining that the cross-zone traffic exceeds a specified threshold, the network bandwidth analysis module 250 initiates the migration of the workload to another node, provided that the target node has sufficient resource for the workload.

In some embodiments, the network bandwidth analysis module 250 collaborates with the auto-scaling module 260 to adjust the number of nodes required for all workloads. The auto-scaling module 260 also monitors other performance metrics, such as CPU utilization, memory usage, and request rates, among others, to determine whether upscaling or downscaling should be performed. In some embodiments, the auto-scaling module 260 performs auto-scaling based on predetermined scaling policies. Various rules and thresholds are defined in these scaling policies, which may include policies related to network bandwidth. The auto-scaling module 260 enables the automatic provisioning or de-provisioning of resources without manual intervention.

In some embodiments, the auto-scaling module 250 is configured to perform vertical scaling, which adjusts the size or capacity of a single node (e.g., upgrading the node's CPU or memory). Alternatively, or in addition, the auto-scaling module 250 is configured to perform horizontal scaling, which adds or removes workloads.

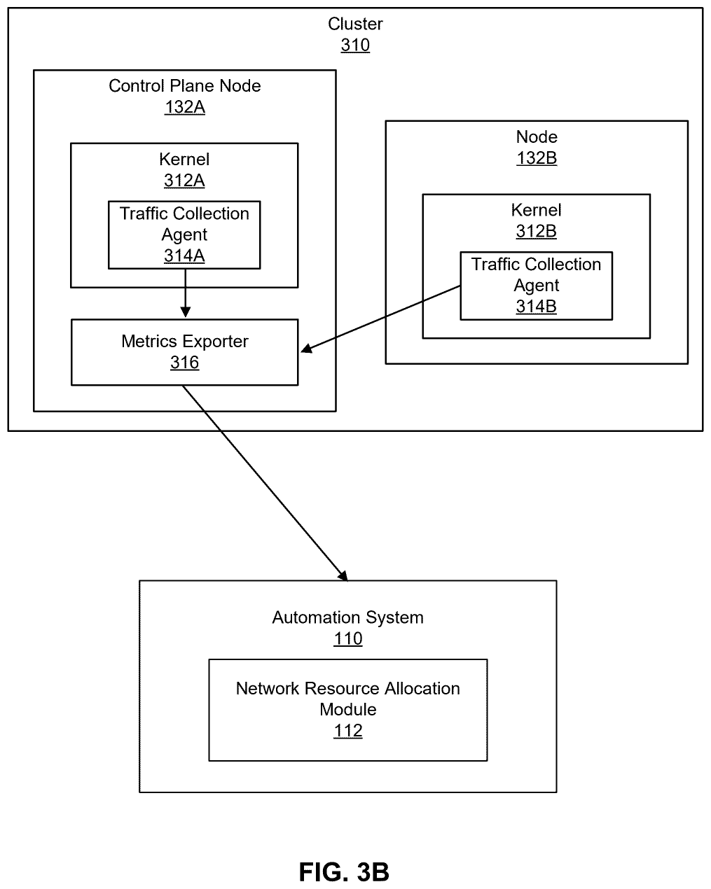

The interface module 280 is configured to provide a graphical user interface (GUI) for interacting with the automation system 110. In some embodiments, the interface module 280 allows users to view network traffic data via graphs, assign network resource to workloads, and configure auto-scaling and migration policies. Example graphical user interfaces (GUIs) are illustrated in FIG. 4 and will be described in detail below.

### Network Metrics Collection Agents

As described above, in some embodiments, an agent is deployed onto each node to monitor traffic on the node and determine network metrics. The determined network metrics are then transmitted to the network resource allocation module 112 for further analysis to determine whether there is sufficient network resource for each node or workload.

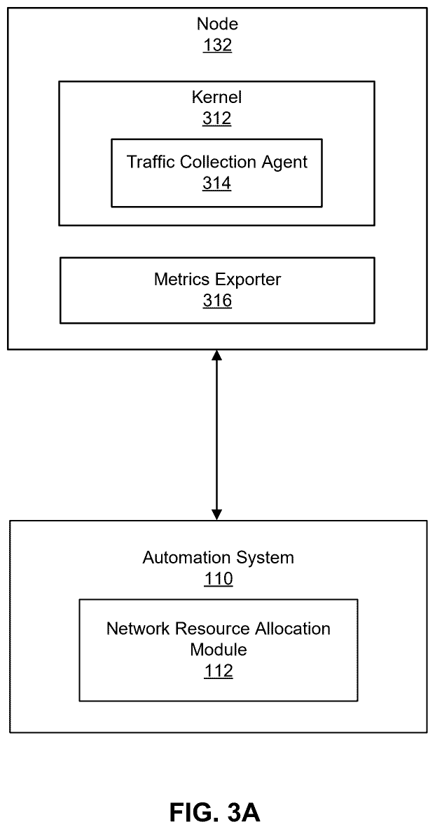

FIG. 3A is a block diagram of a node 132 in which a traffic collection agent 314 is executed in a kernel 312 of the node 132 to collect traffic flow data associated with the node 132 in accordance with one or more embodiments. The node 132 may be a virtual machine (VM) or a Bare metal server that is provisioned from a specific instance family offered by a cloud service provider, such as AWS®, Google Cloud®, or Microsoft Azure®. Cloud service providers offer predefined VM configurations grouped into instance families. An instance family represents a category of VMs with specific hardware specification. The node 132 includes a kernel 312. The kernel 312 is a component of a VM's operating system that directly interacts with virtualized hardware. The kernel 312 performs functions related to resource management (e.g., CPU scheduling, memory management, and I/O management), process management (e.g., handling process creation, scheduling, and termination within the VM, managing inter-process communication), and networking (e.g., providing an abstraction layer for network communication, interacting with virtualized network interfaces), and security (e.g., enforcing access control and isolation between processes to prevent unauthorized access).

A traffic collection agent 314 is deployed in the kernel 312 of the node 132, such that the agent 314 has privileged access to low-level system events. In particular, the traffic collection agent 314 observes incoming and outgoing network traffic by attaching to network-related system calls and kernel hooks in the network stack. In some embodiments, the attached network-related system calls include (but are not limited to) system calls related to socket management, such as socket( ) (which creates a new socket for communication), bind( ) (which binds a socket to a specific local IP address and port), listen( ) (which marks a socket as passive, allowing it to accept incoming connections), accept( ) (which accepts an incoming connection request on a listening socket), connect( ) (which establishes a connection from a client socket to a remote server), and/or close( ) (which closes a socket, terminating the connection).

In some embodiments, the attached network-related system calls include (but are not limited to) system calls related to data transmission, such as send( )/sendto( )/sendmsg( )/sendmmsg ( ) (which send data over a socket), recv( )/recvfrom( )/recvmsg( )/recvmmsg( ) (which receives data from a socket).

In some embodiments, the attached kernel hooks include (but are not limited to) eBPF (Extended Berkley Packet Filter)-based hooks, netfilter hooks, tracepoints, kprobes and/or uprobes. The eBPF-based hooks may include (but are not limited to) traffic control (TC) hooks, which attach at a transport layer (e.g., TCP or UDP) to inspect and filter packets during transmission or reception; XDP (eXpress Data Path) hook, which attach at an earliest point in a networking stack to process packets before they reach higher layers. The attached kernel hooks include (but are not limited to) pre-routing hooks (triggered when a packet arrives at the system before routing decisions are made), input hooks (triggered when a packet is destined for the local system), forward hooks (triggered for packets that are being routed through the system), and/or post-routing hooks (triggered after a packet has been routed and is ready to leave the system).

The traffic collection agent 314 monitors the network traffic data from the kernel 312, aggregates and processes the monitored network traffic data in real time to determine network traffic metrics, such as traffic volumes (e.g., bytes transmitted and received per interface, process, or connection), connections, latency (e.g., round-trip time for TCP connections, application-layer response times), packet statistics (packet drops and retransmissions, packet processing time in kernel, checksum errs or malformed packets), bandwidth usage per connection, interface, or process.

The metric exporter 316 is configured to transmit the determined metrics to the automation system 110 for further analysis, visualization, or optimization. The exporter 316 may use network protocols like HTTP, gRPC, or custom communication protocols to transmit the metrics data. In some embodiments, the metric exporter 316 may perform lightweight aggregation and processing of data to reduce transmission overhead.

The automation system 110 includes a network resource allocation module 112 configured to receive the collected traffic data from the metric exporter 316 of the node 132. Notably, even though only one node is illustrated in FIG. 3A, there may be multiple nodes 132 in the environment. Each of the multiple nodes 132 may include a traffic collection agent 314 configured to monitor and analyze network traffic data from its kernel 312 and determine network traffic metrics. The network resource allocation module 112 receives traffic metrics from each of the multiple nodes 132 to perform further processing and analysis.

These multiple nodes 132 may be part of the same cluster. The nodes may be distributed across different zones or within the same zone. In general, nodes within the same zone perform intra-zone communication with lower latency and lower resource consumption., while nodes in different zones perform cross-zone communication with higher latency and higher resource consumption. The network resource allocation module 112 is configured to aggregate network traffic data among different nodes to identify intra-zone communications and cross-zone communications. In some embodiments, the network resource allocation module 112 is configured to identify a high-volume cross-zone communication between two nodes and recommend migrating one node to the same zone as the other node to reduce cross-zone communication.

In some embodiments, the multiple nodes 132 may be part of a Kubernetes cluster, including a control plane node and one or more nodes. The control plane node communicates with nodes to schedule workloads or pods to nodes, monitor node health and resource utilization, and manage updates and configurations for nodes.

FIG. 3B is a block diagram of a Kubernetes cluster 310 including a control plane node 132A and one or more nodes 132B, in accordance with one or more embodiments. In each of the control plane node 132A and nodes 132B, a traffic collection agent 314A, 314B is executed in a kernel 312A, 312B to collect traffic flow data associated with a corresponding node 132A, 132B. The control plane node 132A also includes a metrics exporter 316, which receives collected traffic data from its own traffic collection agent 314A and traffic collection agents 314B of nodes 132B. The metrics exporter 316 aggregates the received traffic data and transmits the aggregated traffic data to the automation system 110.

### Example Graphical User Interfaces (GUIs)

FIG. 4 illustrates an example graphical user interface (GUI) 400 that provides insights into network costs, traffic, and resource usage across workloads in a Kubernetes-managed environment, in accordance with one or more embodiments. The GUI 400 includes a few navigation tabs at the top, including options for compute cost, network cost, efficiency, and total cost. When the network cost is selected, a top panel displays network costs for individual workloads, such as, Nginx-depl-768787: $89.45, Metrics-EKS-5523: $65.32, X-Agent-Kube: $75.03, Psqci-Nodes-33: $63.11, and Application-Test: $45.33. These values represent a total network costs associated with each workload, which may be determined based on total traffic volume and cross-zone communication.

The GUI 400 also includes a graph section that visualizes the network cost for different workloads over time (e.g., daily across June 2023). The X-axis represents days of the month, and the Y-axis represents network cost (in dollars). Each line corresponds to a workload, allowing users to identify trends, peaks, and anomalies in network costs.

The GUI 400 also includes a workloads table at the bottom. The table includes details about workloads organized into several columns, including workload name, workload type, namespace, pods, total traffic, and total cost. The table also presents details about intra-AZ traffic and cross-AZ traffic. Intra-AZ traffic represents traffic within a same availability zone (e.g., 178.458 GiB) and associated costs (e.g., $24.32). Cross-AZ traffic represents traffic between different availability zones (e.g., 154.452 GiB) and associated costs (e.g., $37.61). Users are allowed to filter workloads by specific labels or namespaces for focused view. A search bar may also allow users to search for specific workloads.

In some embodiments, the system 110 may allow users to request that network performance be monitored against predefined constraints, such as round-trip time <50 ms, packet loss rate <0.1%, and/or cross-zone egress bandwidth <10 Mbps for a specific workload. In response to such constraints, the system 110 can deploy monitoring agents to track relevant metrics. Based on the tracked metrics, the agent detects bandwidth usage by workload and recommends or automates the reallocation of workloads to different nodes, ensuring compliance with the specified constraints.

### Example Code Snippets

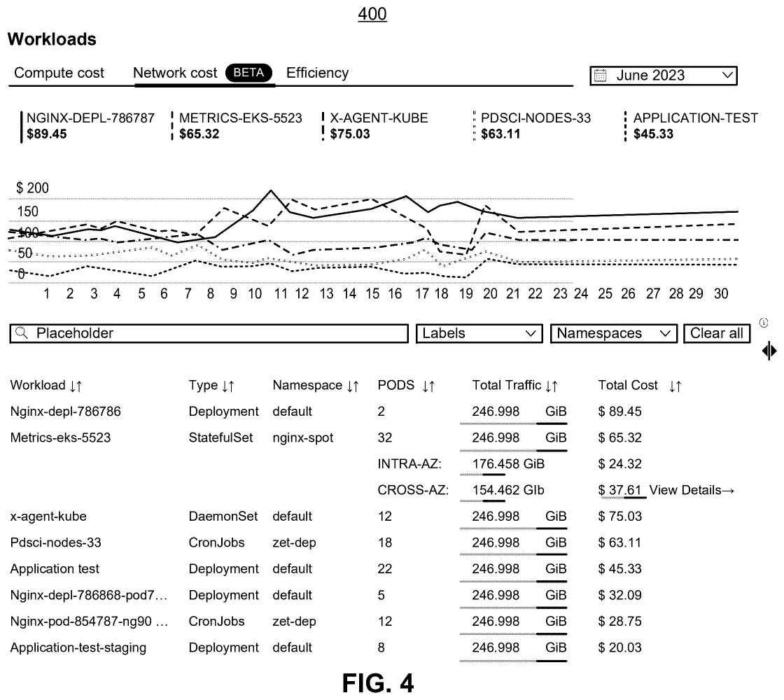

FIG. 5 illustrates an example data structure 500 including a compute instance's attributes, in accordance with one or more embodiments. The data structure 500 may be a JSON object that contains metadata and specifications of the compute instance. This data structure may be pulled from inventory data of the cloud service provider that shows specific instance family's network limit. In some embodiments, the data structure is obtained from the cloud service provider via an API request.

As illustrated, the data structure 500 includes “productFamily”, which specifies a category of the resources, e.g., “Compute Instance.” The data structure 500 also includes attributes, which are nested objects containing the compute instance's specifications, including (but not limited to) “enhancedNetworkingSupported”, “intelTurboAvailable”, “memory”, “dedicatedEbsThroughput”, “vcpu”, “classicenetworkingsupport”, “capacitystatus”, “locationType”, “storage”, “instanceFamily”, “operatingSystem”, “regionCode”, “physicalProcessor”, “clockSpeed”, “ecu”, “networkPerformance”, among others. In particular, “networkPerformance” specifies the instance's maximum network performance, which is “up to 12500 megabit”. Based on the maximum network performance from the data structure, the system 110 can determine whether a node has sufficient network bandwidth capacity for a workload with a network bandwidth requirement. Each time a workload is deployed onto the node, the system 110 can keep tracking the available network bandwidth of node based on the network bandwidth requirement of the workload.

In a Kubernetes environment, the system 110 can define an extended resource as a node's network capacity during the node provisioning process. Node provisioning is a process of creating and configuring a new node before it joins the Kubernetes cluster. This process includes installing required software (e.g., Kubernetes runtime), configuring system resources (CPU, memory, storage, network), and registering the node with the Kubernetes cluster. During this provisioning process, the network capacity (e.g., maximum bandwidth) can be programmatically associated with the node and presented as an extended resource of the node. This ensures that Kubernetes recognizes the node's network bandwidth constraint, and pods requesting specific bandwidth are scheduled only on nodes with specific available capacity.

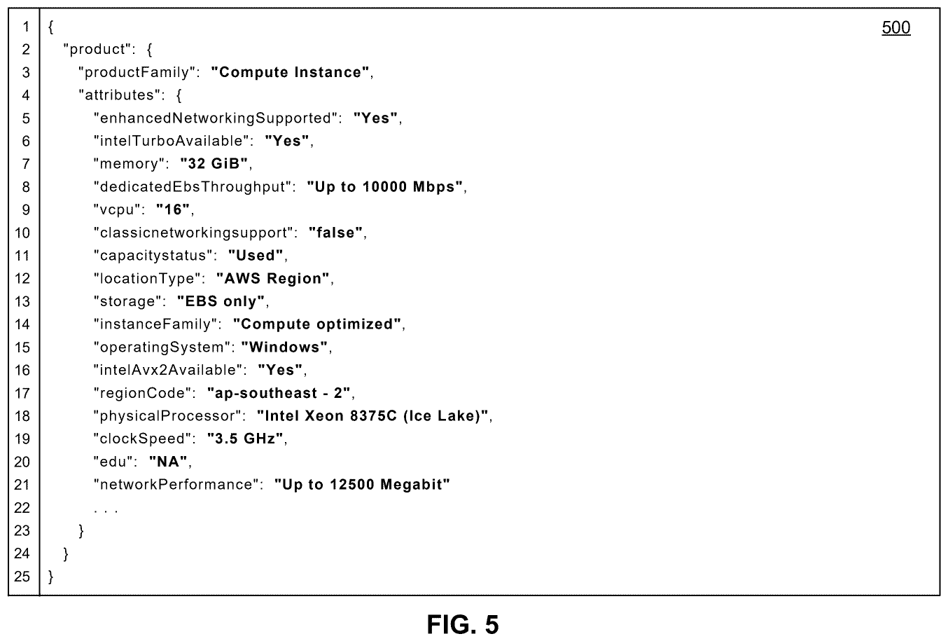

FIG. 6 illustrates an example code snippet 600 that shows that a node has a specific network bandwidth capacity, in accordance with one or more embodiments. The first line “PATCH/api/v1/nodes/<your-node-name>/status HTTP/1.1” sends a PATH request to a Kubernetes API to update the status of a node identified as “your-node-name.” The second line “Accept: application/json” specifies that the response should be in JSON format. The third line “Content-Type: application/json-patch+json” indicates that the request body uses the JSON Patch format, which is a standard for partial updates. The fourth line “Host: k8s-master: 8080” specifies the Kubernetes API server's hostname and port. Here, k8s-master: 8080 refers to the Kubernetes control plane node where the API server is running. Lines 6-12 contain the JSON Patch operation to update the node's resource status. “op” specifies the type of operation. Here “add” adds a new field or updates an existing one. “path” is a JSON pointer path to the field being updated. In this case, it updates the network-bandwidth capacity under the node's status/capacity. “value” of 12500000 represents 12.5 Mbps is being added.

In some embodiments, configuration of a workload or pod also includes network bandwidth requests as its definition when the workload is being deployed in the cloud computing environment. In a cloud computing environment (e.g., Kubernetes), requests are the minimum guaranteed resources a workload or pod will have access to once scheduled on a node. Network bandwidth requests specify how much network bandwidth a workload or pod requires to function properly. This is especially important for workloads where network throughput significantly impacts performance, such as video streaming, real-time data analytics, and/or large-scale distributed systems.

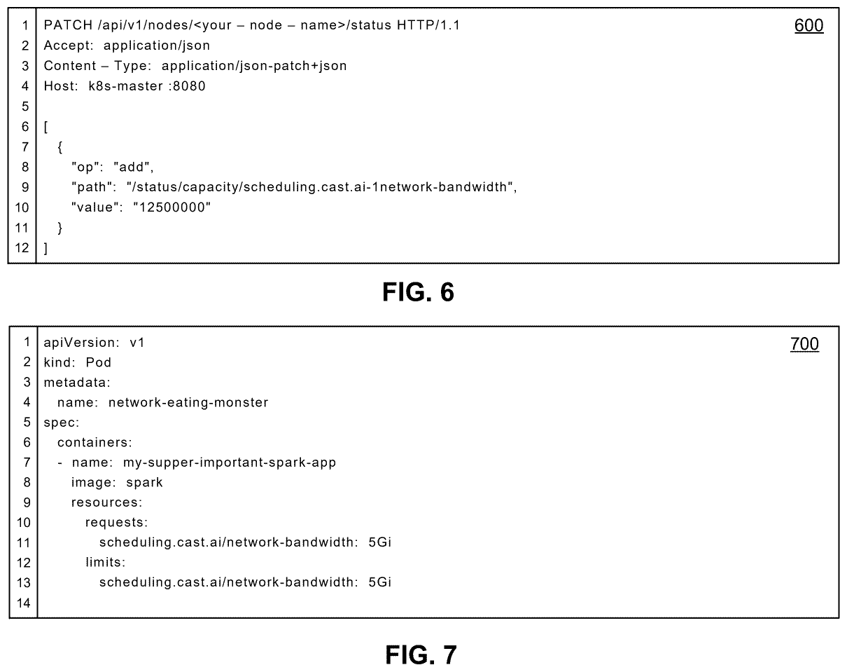

FIG. 7 illustrates an example configuration file 700 describing a Kubernetes Pod with specific resource requests, including limits for network bandwidth using a custom resource field, in accordance with one or more embodiments. The first line “api Version” indicates the API version used for the resource. The second line “kind” specifies the type of Kubernetes resource. Here it is a “pod”. The third line contains metadata about the resource. Here, the name of the resource (i.e., pod) is “network-eating-monster.” Lines 5-13 defines the specification of the pod, including the containers it runs and its resource requirements. In particular, the container is named “my-supper-important-spark-app”; “image” specifies a Docker image used for the container, here spark; and “resource” defines the resource requirements for the container in terms of requests and limits for the custom resource “network-bandwidth.” Here, the minimum amount of network bandwidth required by the container is set of 5Gi; the maximum amount of network bandwidth that the container can use is also 5Gi. By defining both requests and limits to 5Gi, the container is guaranteed 5Gi of network bandwidth without exceeding this value.

### Example Methods for Identifying Process-Level Network Traffic Flows

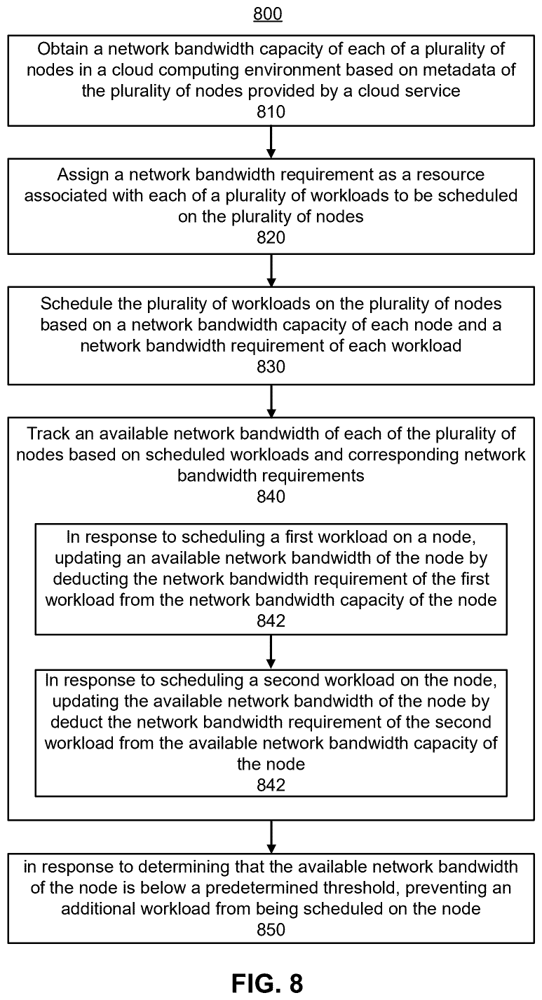

FIG. 8 is a flowchart of a method 800 for network-aware workload scheduling and bandwidth management in a cloud computing environment, in accordance with one or more embodiments. In various embodiments, the method includes different or additional steps than those described in conjunction with FIG. 8. Further, in some embodiments, the steps of the method may be performed in different orders than the order described in conjunction with FIG. 8. The method described in conjunction with FIG. 8 may be carried out by the automation system 110 in various embodiments, while in other embodiments, the steps of the method are performed by any online system capable of performing these steps.

The automation system 110 obtains 810 a network bandwidth capacity of each of a plurality of nodes in a cloud computing environment based on metadata of the plurality of nodes provided by a cloud service. Cloud service providers, such as Amazon Web Service (AWS)®, Google Cloud Platform (GCP)®, or Microsoft Azure®, may provide APIs or other tools to fetch metadata about their compute instances, including network bandwidth capacities. The automation system 110 can use API calls to query the metadata services or inventory systems of the cloud service for instance specifications. In some embodiments, the metadata includes field such as “networkPerformance”, which defines a maximum network bandwidth a node can support. For example, AWS instance types might specify “Up to 12500 Megabit” for network performance, as shown in FIG. 5.

The automation system 110 assigns 820 a network bandwidth requirement as a resource associated with each of a plurality of workloads to be scheduled on the plurality of nodes. In some embodiments, the network bandwidth requirement is assigned to a workload by specifying it in the workload's resource configuration file, as shown in FIG. 7. The configuration file defines the workload (e.g., a Kubernetes Pod) and includes specifications for resource request and limit, including network bandwidth. The resource request refers to a minimum guaranteed network bandwidth required by the workload. If the node does not have this amount available, the workload will not be scheduled on the node. The limit (which cannot be lower than the resource request) refers to a maximum network bandwidth the workload can consume. This limit prevents overconsumption and ensures fair sharing among workloads. In some embodiments, extended resources, requests and limits may be conceptually treated the same, as scheduling is done by limits while requests are ignored.

In some embodiments, the network bandwidth requirement for a workload may be determined and entered by users. Alternatively, the network bandwidth requirement for a workload may be determined based on historical network consumption of the workload.

The automation system 110 schedules 830 the plurality of workloads on the plurality of nodes based on a network bandwidth capacity of each node and a network bandwidth requirement of each workload. As described above, each node has a network bandwidth capacity, which represents the maximum amount of network traffic the node can handle. Each workload has a network bandwidth requirement, which is the minimum amount of network bandwidth needed to execute the workload efficiently. The automation system 110 evaluates both: the available network bandwidth of each node and the bandwidth requirement of each workload that needs to be scheduled. Based on these factors, the automation system 110 selects a node with sufficient available bandwidth to accommodate each work load.

The automation system 110 tracks 840 the available network bandwidth of each node within the plurality of nodes based on scheduled workloads and their corresponding network bandwidth requirements. For example, the automation system 110 schedules a first workload from the plurality of workloads on a node based on the node's network bandwidth capacity and the network bandwidth requirement of the first workload. As described above, the network bandwidth requirement for the first workload indicates the minimum guaranteed network bandwidth needed. Accordingly, the automation system 110 selects a node with a network bandwidth capacity greater than the requirement of the first workload to schedule the workload.

In response to scheduling the first workload on the node, the automation system 110 updates 842 the available network bandwidth of the node by deducting the network bandwidth requirement of the first workload from the node's network bandwidth capacity. In some embodiments, this update occurs in the scheduler's mental model and does not modify the actual node configuration or capacity. For example, if the network bandwidth capacity of the node is 12.5 Gbps, and the network bandwidth requirement for the first workload is 5 Gbps, the available network bandwidth of the node becomes 7.5 Gbps after scheduling the first workload on it.

After that, the system 110 may then schedule a second workload from the plurality of workloads on the node based on the available network bandwidth of the node and the network bandwidth requirement of the second workload. Similar to scheduling the first workload, the system 110 determines whether the available network bandwidth of the node exceeds the network bandwidth requirement of the second workload. Only when the available network bandwidth of the node is greater than the network bandwidth requirement of the second workload can the system 110 schedule the second workload on the node.

In response to scheduling the second workload on the node, the automation system 110 then updates 842 the available network bandwidth of the node by deducting the network bandwidth requirement of the second workload from the available network bandwidth of the node. For example, if the available network bandwidth of the node is 7.5 Gbps, and the network bandwidth requirement of the second workload is 4 Gbps, the available network bandwidth of the node becomes 3.5 Gbps after scheduling the second workload on it.

Notably, the available network bandwidth of the same node decreases each time an additional workload is scheduled on it. Eventually, the node will have insufficient network bandwidth remaining to schedule any additional workloads.

The automation system 110 also determines 850 whether an available network bandwidth of each node is below a predetermined threshold. In response to determining that the available network bandwidth of the node is below the predetermined threshold, the automation system 110 prevents 850 an additional workload from being scheduled on the node. This means the automation system 110 will not assign new workloads to the node, even if the node is not fully utilized in terms of CPU or memory. For example, the threshold may be set at 1 Gbps. In response to determining that the available bandwidth falls below 1 Gbps, the automation system 110 assumes the node is nearing overutilization, and will not assign additional workload to this node. By stopping additional workloads from being scheduled when bandwidth is below the predetermined threshold, the automation system 110 ensures that the existing workloads continue to operate efficiently without being starved of network resources. This is particularly advantageous for bandwidth-sensitive applications, such as video streaming or real-time analytics, which require stable and sufficient bandwidth to function properly.

Moreover, the network bandwidth requirement for each workload may be dynamic. In some embodiments, to obtain real time network bandwidth consumption of each workload, the system 110 deploys an agent on each node. The agent is a lightweight program that operates at the kernel level of the node and monitors network activity in real-time. The agent attaches to network-related system calls and kernel hooks to gather traffic flow data. The agent processes the traffic data in real-time to determine metrics such as ingress and egress traffic rates, packet statistics (e.g., packet drops, retransmissions), latency metrics (e.g., round-trip time, latency jitter), and queue depth. In response to determining these metrics, the agent transmits them to the system 110.

The system 110 can then use the metrics to determine whether a workload should be assigned a higher or lower network bandwidth requirement. In some embodiments, the system 110 updates the network bandwidth requirement for a workload based on current network bandwidth metrics received from the node hosting the workload and adjusts the available network bandwidth of the node accordingly.

In some embodiments, the system 110 also determines whether the available network bandwidth of the node is below a predetermined threshold. In response to determining that the available network bandwidth of the node is below the predetermined threshold, the system 110 evicts a workload from the node, and rescheduling the evicted workload to another node that has sufficient available network bandwidth. Alternatively, in response to determining that no other node has sufficient available network bandwidth, the system 110 provisions an additional node with a network bandwidth capacity greater than the network bandwidth requirement of the workload, evicts the workload from the node, and reschedules the workload to the new node.

### Example Computing System

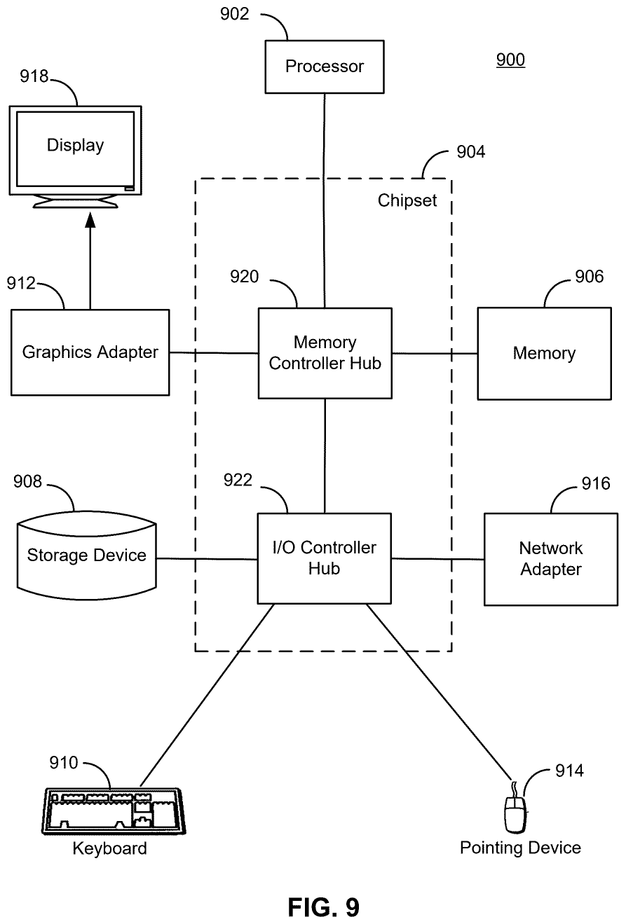

FIG. 9 is a block diagram of an example computer 900 suitable for use in the networked computing environment 100 of FIG. 1. The computer 900 is a computer system and is configured to perform specific functions as described herein. For example, the specific functions corresponding to automation system 110 may be configured through the computer 900.

The example computer 900 includes a processor system having one or more processors 902 coupled to a chipset 904. The chipset 904 includes a memory controller hub 920 and an input/output (I/O) controller hub 922. A memory system having one or more memories 906 and a graphics adapter 912 are coupled to the memory controller hub 920, and a display 918 is coupled to the graphics adapter 912. A storage device 908, keyboard 910, pointing device 914, and network adapter 916 are coupled to the I/O controller hub 922. Other embodiments of the computer 900 have different architectures.

In the embodiment shown in FIG. 9, the storage device 908 is a non-transitory computer-readable storage medium such as a hard drive, compact disk read-only memory (CD-ROM), DVD, or a solid-state memory device. The memory 906 holds instructions and data used by the processor 902. The pointing device 914 is a mouse, track ball, touchscreen, or other types of a pointing device and may be used in combination with the keyboard 910 (which may be an on-screen keyboard) to input data into the computer 900. The graphics adapter 912 displays images and other information on the display 918. The network adapter 916 couples the computer 900 to one or more computer networks, such as network 150.

The types of computers used by the entities and the automation system 110 of FIGS. 1 through 8 can vary depending upon the embodiment and the processing power required by the enterprise. For example, the automation system 110 might include multiple blade servers working together to provide the functionality described. Furthermore, the computers can lack some of the components described above, such as keyboards 910, graphics adapters 912, and displays 918.

### ADDITIONAL CONSIDERATIONS

Traditional systems often overlook network bandwidth allocation, leading to resource contention, degraded performance for bandwidth-sensitive workloads, and inefficient utilization of infrastructure. The automation system 110 described herein introduce network bandwidth as a managed resource, similar to CPU and memory and dynamic adjustment of network bandwidth allocation based on real-time metrics. The system 110 optimizes workload scheduling through continuous monitoring of bandwidth usage and proactive measures, such as rescheduling workloads or provisioning additional nodes when thresholds are exceeded. By integrating these capabilities into existing cloud management frameworks, the system enhances resource efficiency, reduces network congestion, and ensures consistent performance, particularly for high-throughput or low-latency applications in shared environments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcodes, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method, comprising:
obtaining a network bandwidth capacity of each of a plurality of nodes in a cloud computing environment based on metadata of the plurality of nodes provided by a cloud service provider;
assigning a network bandwidth requirement as a resource associated with each of a plurality of workloads scheduled on the plurality of nodes;
scheduling the plurality of workloads on the plurality of nodes based on a network bandwidth capacity of each node and a network bandwidth requirement of each workload;
tracking an available network bandwidth of each of the plurality of nodes based on scheduled workloads and corresponding network bandwidth requirements, comprising:
in response to scheduling a first workload among the plurality of workloads on a node among the plurality of nodes based on the network bandwidth capacity of the node and a network bandwidth requirement of the first workload, updating an available network bandwidth of the node by deducting the network bandwidth requirement of the first workload from the network bandwidth capacity of the node; and
in response to scheduling a second workload among the plurality of workloads on the node based on the available network bandwidth of the node and a network bandwidth requirement of the second workload, updating the available network bandwidth of the node by deducting the network bandwidth requirement of the second workload from the available network bandwidth of the node; and
in response to determining that the available network bandwidth of the node is below a predetermined threshold, preventing an additional workload from being scheduled on the node.

2. The method of claim 1, wherein the network bandwidth requirement for a workload is determined based on historical network usage metrics of the workload.

3. The method of claim 1, further comprising:
collecting current network bandwidth metrics of one of the first workload or the second workload from the node;
updating the network bandwidth requirement for the one of the first workload or the second workload based on the current network bandwidth metrics; and
updating the available network bandwidth for the node based on the updated network bandwidth requirement for the one of the first workload or the second workload.

4. The method of claim 3, wherein the current network bandwidth metrics include one or more of packet loss, queue depth, TCP retransmissions, round trip time, and latency jitter.

5. The method of claim 3, further comprising deploying an agent on each of the plurality of nodes, each agent attached to network-related system calls in a kernel of a corresponding node and configured to monitor real time network traffic based on the network-related system calls in the kernel and determine the current network bandwidth metrics of the first workload or the second workload.

6. The method of claim 3, further comprising:
determining whether a current network bandwidth metric of the node has deteriorated to a predetermined threshold; and
in response to determining that the current network bandwidth metric of the node has deteriorated to the predetermined threshold,
identifying a second node among the plurality of nodes that has sufficient available network bandwidth;
evicting the first workload or the second workload from the node; and
rescheduling the first workload or the second workload to the second node among the plurality of nodes.

7. The method of claim 3, the method further comprising:
determining whether a current network bandwidth metric of the node has deteriorated to a predetermined threshold; and
in response to determining that the current network bandwidth metric of the node has deteriorated to the predetermined threshold,
provisioning an additional node with a network bandwidth capacity greater than the network bandwidth requirement of the first workload or the second workload;
evicting the first workload or the second workload from the node; and
rescheduling the first workload or the second workload to the second node among the plurality of nodes.

8. The method of claim 1, wherein scheduling the first workload and the second workload are further based on additional resource constraints, including CPU requirement for each of the first workload and the second workload and CPU availability of each of the plurality of nodes.

9. A non-transitory computer readable storage medium having instructions encoded thereon that, when executed by one or more processors, cause the one or more processors to perform steps comprising:
obtaining a network bandwidth capacity of each of a plurality of nodes in a cloud computing environment based on metadata of the plurality of nodes provided by a cloud service provider;
assigning a network bandwidth requirement as a resource associated with each of a plurality of workloads scheduled on the plurality of nodes;
scheduling the plurality of workloads on the plurality of nodes based on a network bandwidth capacity of each node and a network bandwidth requirement of each workload;
tracking an available network bandwidth of each of the plurality of nodes based on scheduled workloads and corresponding network bandwidth requirements, comprising:
in response to scheduling a first workload among the plurality of workloads on a node among the plurality of nodes based on the network bandwidth capacity of the node and a network bandwidth requirement of the first workload, updating an available network bandwidth of the node by deducting the network bandwidth requirement of the first workload from the network bandwidth capacity of the node; and
in response to scheduling a second workload among the plurality of workloads on the node based on the available network bandwidth of the node and a network bandwidth requirement of the second workload, updating the available network bandwidth of the node by deducting the network bandwidth requirement of the second workload from the available network bandwidth of the node; and
in response to determining that the available network bandwidth of the node is below a predetermined threshold, preventing an additional workload from being scheduled on the node.

10. The non-transitory computer readable storage medium of claim 9, wherein the network bandwidth requirement for a workload is determined based on historical network usage metrics of the workload.

11. The non-transitory computer readable storage medium of claim 9, the steps further comprising:
collecting current network bandwidth metrics of the first workload or the second workload from the node;
updating the network bandwidth requirement for the first workload or the second workload based on the current network bandwidth metrics; and
updating the available network bandwidth for the node based on the updated network bandwidth requirement for the first workload or the second workload.

12. The non-transitory computer readable storage medium of claim 11, wherein the current network bandwidth metrics include one or more of packet loss, queue depth, TCP retransmissions, round trip time, and latency jitter.

13. The non-transitory computer readable storage medium of claim 11, the steps further comprising deploying an agent on each of the plurality of nodes, each agent attached to network-related system calls in a kernel of a corresponding node and configured to monitor real time network traffic based on the network-related system calls in the kernel and determine the current network bandwidth metrics of the first workload or the second workload.

14. The non-transitory computer readable storage medium of claim 11, the steps further comprising:
determining whether a current network bandwidth metric of the node has deteriorated to a predetermined threshold; and
in response to determining that the current network bandwidth metric of the node has deteriorated to the predetermined threshold,
identifying a second node among the plurality of nodes that has sufficient available network bandwidth;
evicting the first workload or the second workload from the node; and
rescheduling the first workload or the second workload to the second node among the plurality of nodes.

15. The non-transitory computer readable storage medium of claim 11, the steps further comprising:
determining whether a current network bandwidth metric of the node has deteriorated to a predetermined threshold; and
in response to determining that the current network bandwidth metric of the node has deteriorated to the predetermined threshold,
provisioning an additional node with a network bandwidth capacity greater than the network bandwidth requirement of the first workload or the second workload;
evicting the first workload or the second workload from the node; and
rescheduling the first workload or the second workload to the second node among the plurality of nodes.

16. The non-transitory computer readable storage medium of claim 11, wherein scheduling the first workload and the second workload are further based on additional resource constraints, including CPU requirement for each of the first workload and the second workload and CPU availability of each of the plurality of nodes.

17. A system, comprising:
one or more processors; and
a non-transitory computer readable storage medium having instructions encoded thereon that, when executed by the one or more processors, cause the one or more processors to perform steps comprising:
obtaining a network bandwidth capacity of each of a plurality of nodes in a cloud computing environment based on metadata of the plurality of nodes provided by a cloud service provider;
assigning a network bandwidth requirement as a resource associated with each of a plurality of workloads scheduled on the plurality of nodes;
scheduling the plurality of workloads on the plurality of nodes based on a network bandwidth capacity of each node and a network bandwidth requirement of each workload;
tracking an available network bandwidth of each of the plurality of nodes based on scheduled workloads and corresponding network bandwidth requirements, comprising:
in response to scheduling a first workload among the plurality of workloads on a node among the plurality of nodes based on the network bandwidth capacity of the node and a network bandwidth requirement of the first workload, updating an available network bandwidth of the node by deducting the network bandwidth requirement of the first workload from the network bandwidth capacity of the node; and
in response to scheduling a second workload among the plurality of workloads on the node based on the available network bandwidth of the node and a network bandwidth requirement of the second workload, updating the available network bandwidth of the node by deducting the network bandwidth requirement of the second workload from the available network bandwidth of the node; and
in response to determining that the available network bandwidth of the node is below a predetermined threshold, preventing an additional workload from being scheduled on the node.

18. The system of claim 17, wherein the network bandwidth requirement for a workload is determined based on historical network usage metrics of the workload.

19. The system of claim 17, the steps further comprising:
collecting current network bandwidth metrics of one of the first workload or the second workload from the node;
updating the network bandwidth requirement for the one of the first workload or the second workload based on the current network bandwidth metrics; and
updating the available network bandwidth for the node based on the updated network bandwidth requirement for the one of the first workload or the second workload.

20. The system of claim 19, wherein the current network bandwidth metrics include one or more of packet loss, queue depth, TCP retransmissions, round trip time, and latency jitter.
